(19) United States
(12) Patent Application Publication
(10) Pub. No.: US 2025/0148255 A1
(43) Pub. Date: May 8, 2025

(54) METALLIC PACKAGING CONTAINING AN INTEGRATED RFID INLAY

(71) Applicant: Avery Dennison Retail Information Services LLC, Mentor, OH (US)

(72) Inventors: Adnan MEHMOOD, Tampere (FI); Katariina PENTTILA, Tampere (FI); Brad CUMBY, Liberty Township, OH (US)

(21) Appl. No.: 18/726,143

(22) PCT Filed: Jan. 24, 2023
(86) PCT No.: PCT/IB2023/050601

§ 371 Date: Jul. 2, 2024

Related U.S. Application Data
(60) Provisional application No. 63/267,744, filed on Feb. 9, 2022.

(51) Int. Cl. G06K 19/077; H01Q 1/22; H01Q 13/10

(52) U.S. Cl. CPC G06K 19/07749; H01Q 1/2208; H01Q 13/10

(57) ABSTRACT

A two-part RFID antenna, metallic packaging containing the same as part of an integrated RFID inlay, and methods of making and using thereof are described herein. In some embodiments, the two-part antenna contains a feed element and a radiative element. In some embodiments, the feed element is an antenna which sends and/or receives radio signals from an RFID reader/scanner. In some embodiments, the second element is a radiative element which radiates the radio signals received by or sent from the antenna. In some embodiments, the radiative element is a metallic packaging. The prototypes described herein exhibited good sensitivity and operating rang

### CROSS-REFERENCE TO RELATED APPLICATION

The present application claims the benefit of U.S. Provisional Patent Application No. 63/267,744, filed Feb. 9, 2022, which is incorporated herein by reference in its entirety.

### FIELD

RFID inlays to be incorporated in metallic packagings, bags or pouches are described herein.

### BACKGROUND

Conventional RFID tags exhibit poor, or no, performance when located on or near a metallic surface. This is due to the fact that metal is a good reflector-metal surfaces reflect the radio waves generated by an RFID reader which creates interference making it difficult or impossible for the tag to receive or transmit radio signals from and to the reader.

Attempts to overcome this interference have been described. One solution involved incorporating a spacer layer, for example a foam layer, to provide separation between the antenna and the metal surface. However, these constructions are thicker than conventional RFID tags which may make them unsuitable for certain applications and/or adversely affect the aesthetics/size of the tag. Further, additional materials can increase the complexity and cost of manufacture.

Therefore, there exists a need for an RFID inlay/tag or improved RFID inlay/tag that can be used with metal packaging.

There also exists a need for an RFID inlay/tag or improved RFID inlay/tag that can be used with metal packaging that can be used for a variety of applications and/or in different markets/segments.

There also exists a need for an RFID inlay/tag or improved RFID inlay/tag that can be used with metal packaging, wherein the inlay/tag retains the dimensions of conventional RFID inlays/tags (e.g., thickness, etc.).

There also exists a need for an RFID inlay/tag or improved RFID inlay/tag that can be used with metal packaging, wherein the inlay/tag retains the dimensions (e.g., thickness, etc.) and/or the aesthetics are not adversely affected.

### BRIEF DESCRIPTION OF THE DRAWINGS

FIG. 1 is a schematic drawing of an exemplary metallic packaging with an integrated RFID inlay with the slot antenna located near an edge of the metallic packaging.

FIG. 2 is a schematic drawing of an exemplary metallic packaging with the slot antenna completely surrounded by metallic material.

FIG. 3 is a schematic drawing of an exemplary metallic packaging with the slot antenna having an H-form.

FIG. 4 is a schematic drawing of an exemplary metallic packaging with the slot antenna having an L-form.

### SUMMARY

A two-part RFID antenna, metallic packaging containing the same as part of an integrated RFID inlay, and methods of making and using thereof are described herein.

In some embodiments, the two-part antenna contains a feeding element and a radiative element. In some embodiments, the feeding element is an antenna which sends and/or receives radio signals from an RFID reader/scanner. In some embodiments, the antenna is a slot antenna.

The dimensions of the slot antenna can be varied depending on desired properties, application, etc. The antenna may be formed of any material known in the art as suitable for RFID antenna. This includes, but is not limited to, metals, metallic foils, conducting inks, etc. In some embodiments, antenna is formed using a metallic foil, such as aluminum. Other antenna types may be used depending on the application and other parameters.

In some embodiments, the second element is a radiative element which radiates the radio signals received by or sent from the antenna. In some embodiments, the radiative element is a metallic packaging, such as a pouch, bag, envelope, box, carton, etc.

The prototypes described herein exhibited good sensitivity and operating distance, well suiting for inventory management, track and trace, and consumer/customer engagement.

In some embodiments, the RFID inlay is the combination of the feeding element and the radiative element, e.g., forming a feeding element, such as a slot antenna in the metallic packaging. It can be uniquely designed in that the label is integrated as part of the product making the tag less visible and more convenient to use and requiring less resources and materials to manufacture, which reduces costs.

### DETAILED DESCRIPTION

### I. Definitions

“Integrated” as used herein means that the metallic packaging and the antenna together form the RFID inlay. The antenna is the “Feeding Element” which sends a signal to, or receives a signal from, an RFID reader or scanner. The metallic packaging is the “Radiating Element” which radiates the signal to or from the antenna.

### II. Metallic Packaging Containing an Integrated RFID Inlay

A two-part RFID antenna, metallic packaging containing the same as part of an integrated RFID inlay, and methods of making and using thereof are described herein.

### A. Feeding Element

In some embodiments, the antenna is a two-part antenna, in which one part is a feeding element, which sends or receives a radio signal from an RFID reader/scanner and the second part is a radiating element, which radiates the radio signal to or from the feeding element.

In some embodiments, the antenna is as described above and the feeding element is an antenna. In some embodiments, the antenna can be any antenna type or structure known in the art. In some embodiments, the antenna is a slot antenna. A slot antenna typically contains a metal surface, usually a flat plate or other flat or semi-flat surface, with one or more holes or slots cut out. When the plate or surface is driven as an antenna by an applied radio frequency current, the slot radiates electromagnetic waves in a way similar to a dipole antenna. The shape and size of the slot, as well as the driving frequency, determine the radiation pattern. Slot antennas are typically used at UHF and microwave frequencies at which wavelengths are small enough that the plate/surface and slot are conveniently small. At these frequencies, the radio waves can be conducted by a waveguide, and the antenna contains slots in the waveguide; this is called a slotted waveguide antenna. The antenna can contain multiple slots in order to act as a directive array antenna and can emit a narrow fan-shaped beam of radio waves. A slot antenna's main advantages are its size, design simplicity, and convenient adaptation to mass production techniques.

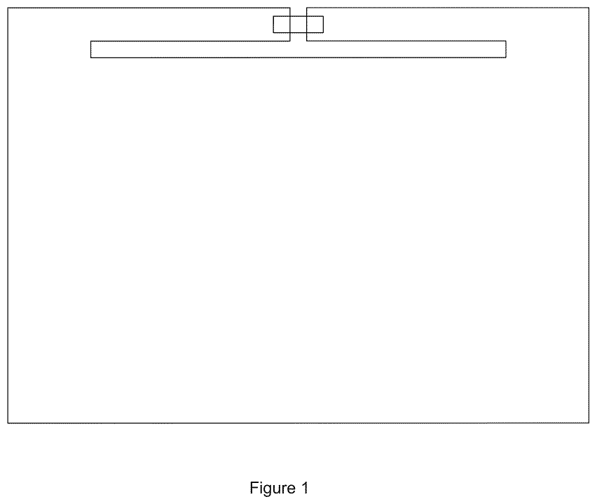

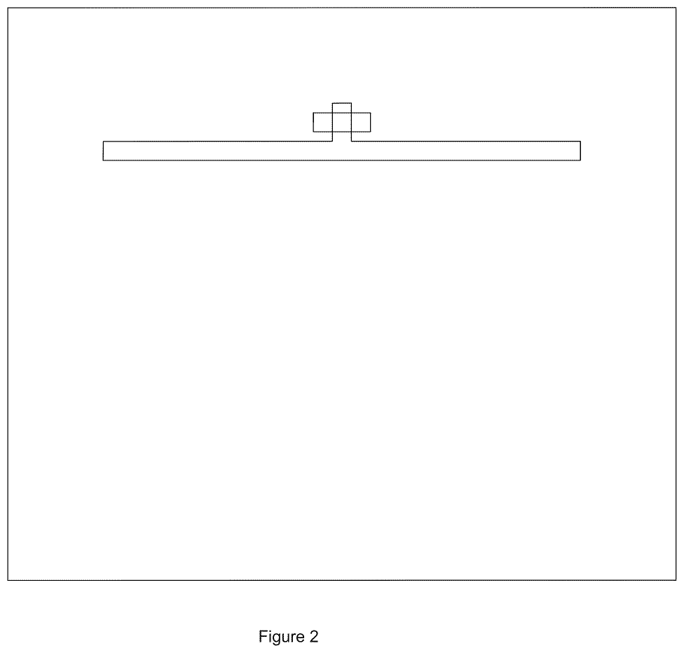

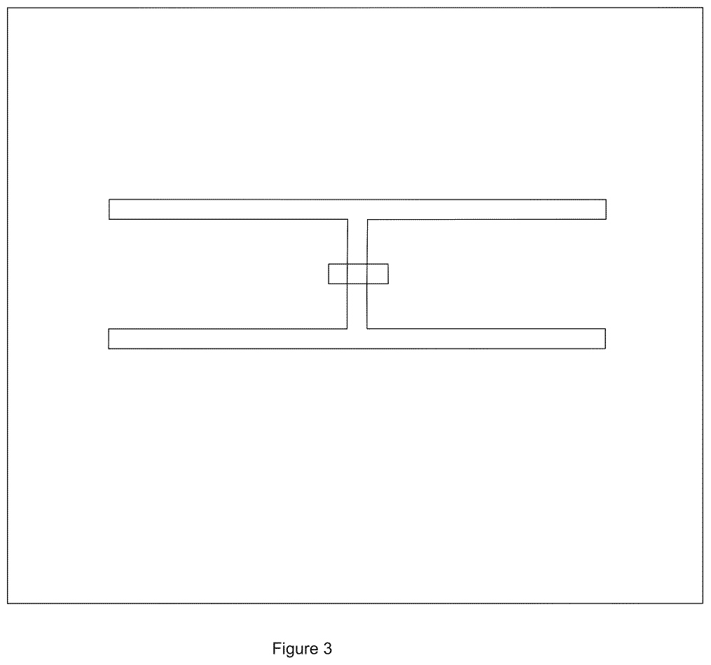

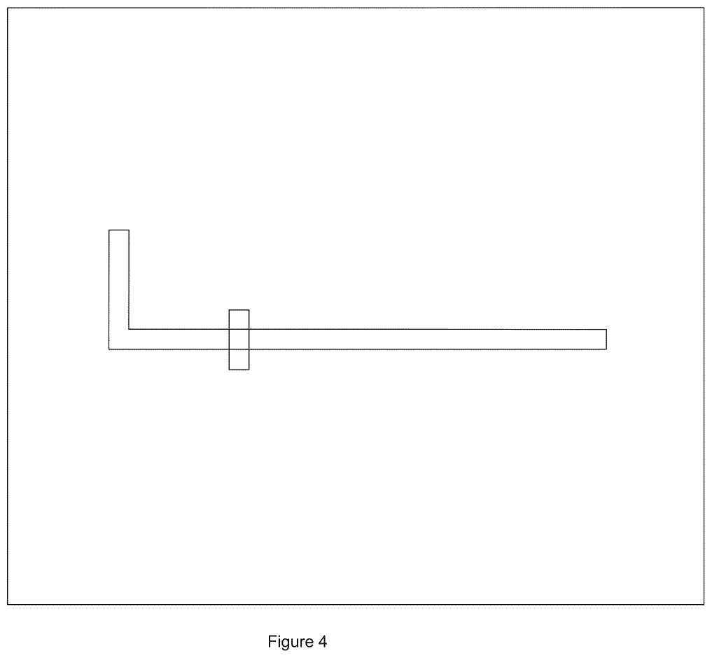

The dimensions of the slot antenna can be varied depending on desired properties, application, etc. In some embodiments, the slot antenna can be a linear slot. In some embodiments, the slot can be formed like a “T” (FIG. 1). In some embodiments the slot can be formed like an “H” (FIG. 3). In some embodiments the slot antenna can be formed like an “L” (FIG. 4). In some embodiments the slot antenna can be located near an edge of the metallic packaging (FIG. 1). In some embodiments the slot can be open to the edge. In some embodiments, the slot antenna can be completely encircled by the metallic material of the metallic packaging (FIG. 2). In some embodiments the slot antenna can be located far away from any edge of the metallic packaging. In some embodiments, the slot of the slot antenna is covered with a dielectric material to prevent any loss of the content of the metallic packaging.

In some embodiments an electrical equivalent to a slot antenna is used. A slot antenna electrically looks like an inductor, which tunes an electrical impedance of the chip to the metallic packaging. An electrically equivalent element may be a small inductor or other structure that functions equivalently.

The antenna may be formed of any material known in the art as suitable for RFID antenna. This includes, but is not limited to, metals, metallic foils, conducting inks/resins, etc. In some embodiments, the antenna is formed using a metallic foil, such as aluminum. Other antenna types may be used depending on the application and other parameters.

### B. Radiating Element

In some embodiments, the antenna contains a feeding element as described above and a radiating element. In some embodiments, the radiating element is a metallic packaging. Non-limiting examples of metallic packaging include pouches, bags, envelopes, boxes, cartons, etc. The dimensions of the radiating element (e.g., packaging) can be varied based on application and/or other parameters. In some embodiments, the radiating element is a metallic packaging in the form of a metallic pouch of any size.

### III. Performance

Proximity sensitivity is a concern for RFID inlays on products that are transported, stored, and/or displayed in close proximity to each other. This can be further adversely affected when the metallic packaging described herein since metallic materials/surface can reflect the radio waves being sent to read the RFID tag there by decreasing readability and thus accuracy.

Proximity testing is described below in the Examples. All of the prototypes of the packaging described herein exhibited good sensitivity.

The theoretical read distance forward was also evaluated for the metallic packaging with integrated RFID inlay described herein. Read distances at typical frequencies in the UHF range, suited for inventory management, track and trace, and consumer/customer engagement, range from 30 cm up to over 10 m.

### IV. Applications

The packaging with integrated RFID inlay described herein can be used for a variety of applications. In some embodiments, the packaging with integrated RFID inlay is used to package food or food products including, but not limited to, ready to eat foods and prepared foods and foods that need to be heat up or cooked. The incorporation of the RFID inlay into the packaging allows manufacturers, retailers, and/or consumers to obtain information about the product inside. For example, manufactures and retailers can scan the RFID tag for inventory management, track and trace, duration of storage/exposure to storage conditions, etc. Consumers can scan the RFID tag to learn more about the food or food product, such as preparation instruction, nutritional information, source information, complementary products, coupons, etc.

### IV. Methods of Manufacturing

The metallic packaging with integrated RFID inlay described herein can be manufactured using techniques known in the art or modifications thereof. In some embodiments, the Feeding Element, e.g., slot antenna can be manufactured using techniques known in the art including, but not limiting, die cutting, laser cutting, etching, or combinations thereof.

The integrated circuit, or IC or chip, can be directly attached to the antenna or attached by using a strap attach process, both of which are known in the art. The standard elements of the strap include the RFID chip and conductive leads. The conductive leads are forming a contacting zone for the contacts of the RFID chip and an electrical “bridge” to the antenna. The strap also may include a substrate to support the RFID chip and the conductive leads. The IC can be coupled to the antenna via a conductive connection, an electric field connection, a magnetic field connection, or a combination thereof.

1. A two-part RFID inlay comprising
a. a feeding element; and
b. a radiating element,
wherein the radiating element is a metallic packaging or container.

2. The inlay of claim 1, wherein the feeding element is a slot antenna.

3. The inlay of claim 1, wherein the metallic packaging or container is a pouch.

4. The inlay of claim 1, wherein the metallic packaging or container is a bag.

5. The inlay of claim 1, wherein the metallic packaging or container is an envelope.

6. A metallic packaging comprising the integrated inlay of claim 1.

7. A method of manufacturing the inlay of claim 1, comprising a strap attachment process.

8. The method of claim 7, wherein the strap comprises an RFID chip connected to two or more conductors that can be coupled to an antenna.

9. The method of claim 8, wherein the coupling comprises a conductive connection, an electric field connection, a magnetic field connection, or a combination thereof.

10. The method of claim 7, wherein the inlay is a wet (adhesive) inlay.

11. The method of claim 7, wherein the inlay is a dry (web) inlay.

12. The two-part RFID inlay of claim 1, wherein the feeding element comprises an integrated circuit (IC) or chip.

13. The inlay of claim 1, wherein the feeding element comprises an electrically equivalent element to a slot antenna.

14. The inlay of claim 1, wherein the slot antenna or electrically equivalent element is located anywhere on the metallic package, wherein the slot antenna or equivalent element is completely surrounded by a metallic surface of the metallic packaging.

15. A method of manufacturing the inlay of claim 14 comprising contacting an RFID chip and electrical elements that couple electrically to the slot antenna or electrically equivalent element in a direct or indirect manner.

16. The method of claim 15, wherein the inlay is a label.
